(19) United States
(12) Patent Application Publication
(10) Pub. No.: US 2010/0195096 A1
(43) Pub. Date: Aug. 5, 2010

(54) HIGH EFFICIENCY MULTI WAVELENGTH LINE LIGHT SOURCE

(75) Inventor: Asaf Schlezinger, Sunnyvale, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/575,224

(22) Filed: Oct. 7, 2009

Related U.S. Application Data
(60) Provisional application No. 61/149,942, filed on Feb. 4, 2009.

(51) Int. Cl. G01N 21/88; H04N 5/335

(52) U.S. Cl. 356/237.5; 348/311; 250/552; 348/E05.091

(57) ABSTRACT

Embodiments of the present invention provide apparatus and method for inspecting a substrate. Particularly, embodiments of the present invention provide apparatus and method for detecting pinholes in one or more light absorbing films deposited on a substrate. One embodiment of the present invention provides an inspection station comprising an illumination assembly having a first light source providing light of wavelengths in a first spectrum and a second light source providing light of wavelengths in a second spectrum, wherein light in the first spectrum and second spectrum can be absorbed by light absorbing films on the substrate.

### CROSS-REFERENCE TO RELATED APPLICATIONS

This application claims benefit to U.S. Provisional Patent Application Ser. No. 61/149,942 (Docket No. 13847L), filed Feb. 4, 2009, entitled “Metrology and Inspection Suite for a Solar Production Line”, which is incorporated herein by reference.

### BACKGROUND OF THE INVENTION

1. Field of the Invention

Embodiments of the present invention generally relate to a suite of modules for quality inspection and collection of metrology data during manufacture of a solar cell device in a production line. Particularly, embodiments of the present invention provide apparatus and method for detecting defects in thin film solar cells during manufacturing.

2. Description of the Related Art

Photovoltaic (PV) devices or solar cells are devices which convert sunlight into direct current (DC) electrical power. Typical thin film type PV devices, or thin film solar cells, have one or more p-i-n junctions. Each p-i-n junction comprises a p-type layer, an intrinsic type layer, and an n-type layer. When the p-i-n junction of the solar cell is exposed to sunlight (consisting of energy from photons), the sunlight is converted to electricity through the PV effect. Solar cells may be tiled into larger solar arrays. The solar arrays are created by connecting a number of solar cells and joining them into panels with specific frames and connectors.

Typically, a thin film solar cell includes active regions, or photoelectric conversion units, and a transparent conductive oxide (TCO) film disposed as a front electrode and/or as a backside electrode. The photoelectric conversion unit includes a p-type silicon layer, an n-type silicon layer, and an intrinsic type (i-type) silicon layer sandwiched between the p-type and n-type silicon layers. Several types of silicon films including microcrystalline silicon film (μc-Si), amorphous silicon film (a-Si), polycrystalline silicon film (poly-Si), and the like may be utilized to form the p-type, n-type, and/or i-type layers of the photoelectric conversion unit. The backside electrode may contain one or more conductive layers. There is a need for an improved process of forming a solar cell that has good interfacial contact, low contact resistance, and high overall performance.

Various inspections are generally performed to assure the quality of the solar cell devices and diagnose or tune production line processes during manufacturing of the solar cell devices. For example, pinholes may generate within the thin films of the solar device when undesired particles drop on the substrate during processing. An inspection station is usually used to detect these pinholes. When the number and/or size of pinholes reach certain value, the substrate may be deemed to be in poor quality and pulled from the production line before further processing. Persistent pinholes may indicate that processing chambers need to be cleaned.

The inspection station generally takes two images of the substrate using two light sources having different wavelength. However, in order to get two images, an inspection station usually inspects the substrate twice, or using two sets of cameras and light sources, or degrading the light source efficiency.

Embodiments of the present invention provide methods and apparatus to improve efficiency of the inspection station by avoiding double inspection and double cameras, and increasing light source efficiency.

### SUMMARY OF THE INVENTION

Embodiments of the present invention generally relate to a suite of modules for quality inspection and collection of metrology data during manufacture of a solar cell device in a production line. Particularly, embodiments of the present invention provide apparatus and method for detecting defects in thin film solar cells during manufacturing.

One embodiment of the present invention provides an inspection module comprising a frame allowing a substrate to pass therethrough, an illumination source assembly attached to the frame, wherein the illumination source assembly comprises a first light source providing light of wavelengths in a first spectrum, and a second light source providing light of wavelengths in a second spectrum, an image sensor assembly attached to the frame, wherein the substrate is configured to pass through between the illumination source assembly and the image sensor assembly, and the illuminating source assembly is positioned to direct light source towards the image sensor assembly.

Another embodiment of the present invention provides an inspection module comprising a frame having an opening to allow a substrate to pass therethrough, a line illumination source attached to the frame at one side of the opening, wherein the line illumination source comprises a plurality of first light emitting diodes (LEDs) configured to emit light of wavelengths within a first spectrum, and a plurality of second light emitting diodes (LEDs) configured to emit light of wavelengths within a second spectrum, wherein the first LEDs and the second LEDs are alternately disposed along a line, and the first spectrum is different from the second spectrum, a line image sensor attached to the frame on an opposite side of the opening, wherein the line image sensor is configured to detect light from the line illumination source.

Yet another embodiment of the present invention provides a method for inspecting a substrate comprising feeding a substrate through an inspection station, inspecting the substrate while moving the substrate through the inspection station, wherein the substrate has a first light absorbing film deposited thereon, and inspecting the substrate comprises directing a first pulse of light within a first spectrum from a light source towards the substrate, wherein the first spectrum is absorbable by the first light absorbing film, measuring the first pulse of light passing through the substrate by capturing a first image using an image sensor assembly, wherein the image sensor assembly and the light source are disposed on opposite sides of the substrate, and determining whether a hole exists in the first light absorbing film from the first image.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a side cross-sectional view of a thin film solar cell device according to one embodiment described herein.

FIG. 1B is a side cross-sectional view of a thin film solar cell device according to one embodiment described herein.

FIG. 2 illustrates a plan view of a solar cell production line according to one embodiment described herein.

FIG. 3A schematically illustrates a method for substrate inspection in accordance with one embodiment of the present invention.

FIG. 3B schematically illustrates a method for substrate inspection in accordance with another embodiment of the present invention.

FIG. 4 is an isometric view of an optical inspection module according to one embodiment described herein.

FIG. 5 is a schematic sectional view of an inspection module according to one embodiment of the present invention.

FIG. 6A is a schematic chart showing intensity of a light source without a diffuser across the width of the inspection module.

FIG. 6B is a schematic chart showing intensity of the light source with a diffuser across the width of the inspection module.

FIG. 6C is a schematic chart showing power sequence of a light source of the inspection module during inspection.

FIG. 7 is a flow chart of a method for inspecting a substrate in accordance with one embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention generally relate to a suite of modules for quality inspection and collection of metrology data during manufacture of a solar cell device in a production line. Particularly, embodiments of the present invention provide apparatus and method for detecting defects in thin film solar cells during manufacturing.

Embodiments of the present invention provide apparatus and method for detecting pinholes in one or more light absorbing films deposited on a substrate. One embodiment of the present invention provides an inspection station comprising an illumination assembly having a first light source providing light of wavelengths in a first spectrum and a second light source providing light of wavelengths in a second spectrum, wherein light in the first spectrum and second spectrum can be absorbed by different light absorbing films on the substrate. The inspection station further comprises an image sensor captures images of the substrate from lights penetrating through the substrate. In one embodiment, the first light source and the second light source are pulsed alternately as the substrate is moving through the inspection while the image sensor captures frames of images. Embodiments of the present invention further comprises determining whether defects, such as pinholes and particle pinholes, exist in the light absorbing films on the substrate by comparing the images from the first light source and the second light source.

Embodiments of the present invention can obtain two images of a substrate from two light sources without inspecting the substrate twice, or doubling the number of cameras or other sensors, or degrading efficiencies of the light source.

### Solar Cell Fabrication System

Embodiments of the present invention are described in relation to a system used to form solar cell devices using processing modules adapted to perform one or more processes in the formation of the solar cell devices. In one embodiment, the system is adapted to form thin film solar cell devices by accepting a large unprocessed substrate and performing multiple deposition, material removal, cleaning, sectioning, bonding, and various inspection and testing processes to form multiple complete, functional, and tested solar cell devices that can then be shipped to an end user for installation in a desired location to generate electricity. In one embodiment, the system provides inspection of solar cell devices at various levels of formation, while collecting and using metrology data to diagnose, tune, or improve production line processes during the manufacture of solar cell devices. While the discussion below primarily describes the formation of silicon thin film solar cell devices, this configuration is not intended to be limiting as to the scope of the invention since the apparatus and methods disclosed herein can also be used to form, test, and analyze other types of solar cell devices, such as III-V type solar cells, thin film chalcogenide solar cells (e.g., CIGS, CdTe cells), amorphous or nanocrystalline silicon solar cells, photochemical type solar cells (e.g., dye sensitized), crystalline silicon solar cells, organic type solar cells, or other similar solar cell devices.

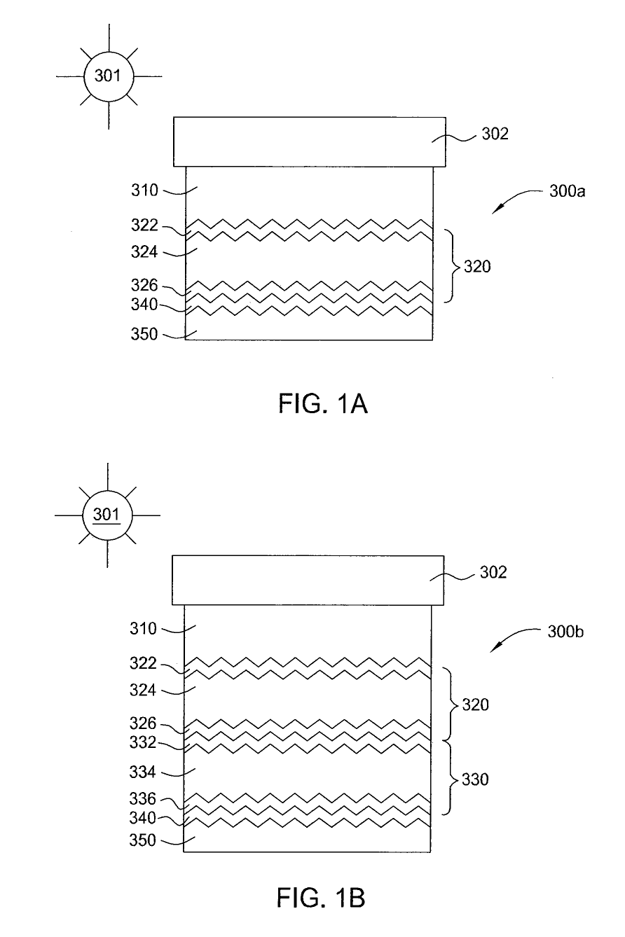

FIG. 1A is a simplified schematic diagram of a single junction amorphous or micro-crystalline silicon solar cell 300a that can be formed and analyzed in the system described below.

As shown in FIG. 1A, the single junction amorphous or micro-crystalline silicon solar cell 300a is oriented toward a light source or solar radiation 301. The solar cell 300a generally comprises a substrate 302, such as a glass substrate, polymer substrate, metal substrate, or other suitable substrate, with thin films formed thereover.

In one embodiment, the substrate 302 is a glass substrate that is about 2200 mm×2600 mm×3 mm in size. The solar cell 300a further comprises a first transparent conducting oxide (TCO) layer 310 (e.g., zinc oxide (ZnO), tin oxide (SnO)) formed over the substrate 302, a first p-i-n junction 320 formed over the first TCO layer 310, a second TCO layer 340 formed over the first p-i-n junction 320, and a back contact layer 350 formed over the second TCO layer 340.

To improve light absorption by enhancing light trapping, the substrate and/or one or more of the thin films formed thereover may be optionally textured by wet, plasma, ion, and/or mechanical processes. For example, in the embodiment shown in FIG. 1A, the first TCO layer 310 is textured, and the subsequent thin films deposited thereover generally follow the topography of the surface below it.

In one configuration, the first p-i-n junction 320 may comprise a p-type amorphous silicon layer 322, an intrinsic type amorphous silicon layer 324 formed over the p-type amorphous silicon layer 322, and an n-type microcrystalline silicon layer 326 formed over the intrinsic type amorphous silicon layer 324. In one example, the p-type amorphous silicon layer 322 may be formed to a thickness between about 60 Å and about 300 Å, the intrinsic type amorphous silicon layer 324 may be formed to a thickness between about 1,500 Å and about 3,500 Å, and the n-type microcrystalline semiconductor layer 326 may be formed to a thickness between about 100 Å and about 400 Å. The back contact layer 350 may include, but is not limited to a material selected from the group consisting of Al, Ag, Ti, Cr, Au, Cu, Pt, alloys thereof, and combinations thereof.

FIG. 1B is a schematic diagram of an embodiment of a solar cell 300b, which is a multi-junction solar cell that is oriented toward the light or solar radiation 301. The solar cell 300b comprises a substrate 302, such as a glass substrate, polymer substrate, metal substrate, or other suitable substrate, with thin films formed thereover.

The solar cell 300b may further comprise a first transparent conducting oxide (TCO) layer 310 formed over the substrate 302, a first p-i-n junction 320 formed over the first TCO layer 310, a second p-i-n junction 330 formed over the first p-i-n junction 320, a second TCO layer 340 formed over the second p-i-n junction 330, and a back contact layer 350 formed over the second TCO layer 340.

In the embodiment shown in FIG. 1B, the first TCO layer 310 is textured, and the subsequent thin films deposited thereover generally follow the topography of the surface below it. The first p-i-n junction 320 may comprise a p-type amorphous silicon layer 322, an intrinsic type amorphous silicon layer 324 formed over the p-type amorphous silicon layer 322, and an n-type microcrystalline silicon layer 326 formed over the intrinsic type amorphous silicon layer 324. In one example, the p-type amorphous silicon layer 322 may be formed to a thickness between about 60 Å and about 300 Å, the intrinsic type amorphous silicon layer 324 may be formed to a thickness between about 1,500 Å and about 3,500 Å, and the n-type microcrystalline semiconductor layer 326 may be formed to a thickness between about 100 Å and about 400 Å.

The second p-i-n junction 330 may comprise a p-type microcrystalline silicon layer 332, an intrinsic type microcrystalline silicon layer 334 formed over the p-type microcrystalline silicon layer 332, and an n-type amorphous silicon layer 336 formed over the intrinsic type microcrystalline silicon layer 334. In one example, the p-type microcrystalline silicon layer 332 may be formed to a thickness between about 100 Å and about 400 Å, the intrinsic type microcrystalline silicon layer 334 may be formed to a thickness between about 10,000 Å and about 30,000 Å, and the n-type amorphous silicon layer 336 may be formed to a thickness between about 100 Å and about 500 Å. The back contact layer 350 may include, but is not limited to a material selected from the group consisting of Al, Ag, Ti, Cr, Au, Cu, Pt, alloys thereof, and combinations thereof.

The p-i-n junctions 320, 330 are configured to absorb energy from different ranges of wavelengths, therefore, providing higher converting efficiency for the solar cell 300b. For example, the p-i-n junction 320 with intrinsic type amorphous silicon layer 324 absorbs wavelength of lights near the color red, while the p-i-n junction 330 with microcrystalline intrinsic silicon layer 334 absorbs wavelength of lights near the color blue.

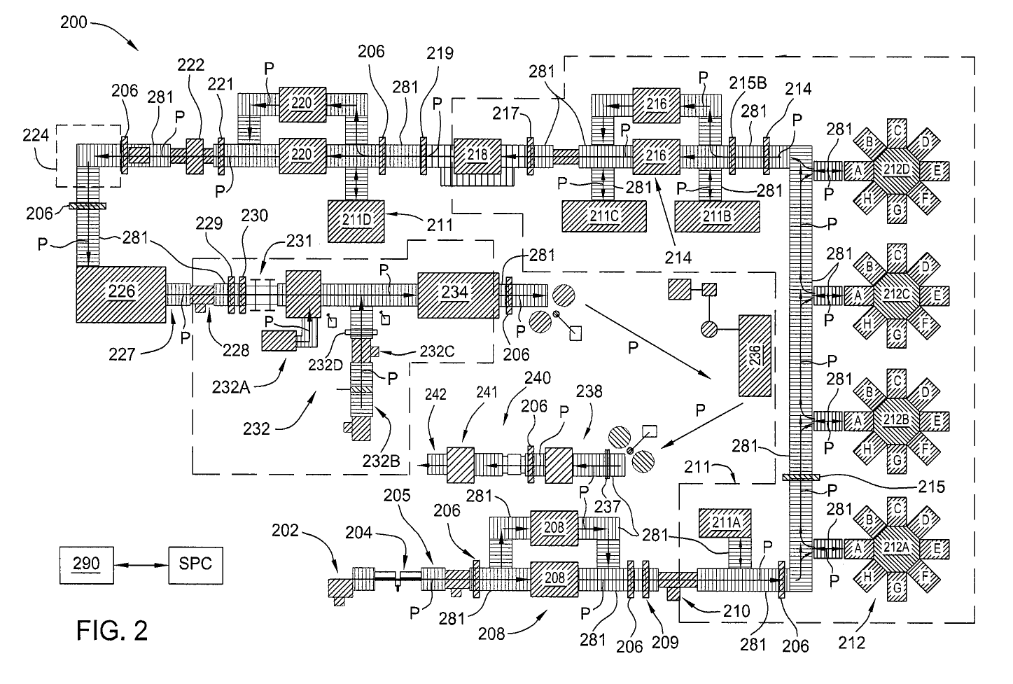

The solar cells 300a, 300b are generally fabricated and packaged in a production line. FIG. 2 is a plan view of one embodiment of a production line 200, which is intended to illustrate some of the typical processing modules and process flows through the system and other related aspects of the system design, and is thus not intended to be limiting to the scope of the invention described herein.

In general, a system controller 290 may be used to control one or more components found in the solar cell production line 200. The system controller 290 is generally designed to facilitate the control and automation of the overall solar cell production line 200. The system controller 290 typically includes a central processing unit (CPU) (not shown), memory (not shown), and support circuits (or I/O) (not shown).

Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 290 determines which tasks are performable on a substrate. Preferably, the program is software readable by the system controller 290 that includes code to perform tasks relating to monitoring, execution and control of the movement, support, and/or positioning of a substrate along with the various process recipe tasks and various chamber process recipe steps being performed in the solar cell production line 200.

In one embodiment, the system controller 290 also contains a plurality of programmable logic controllers (PLC's) that are used to locally control one or more modules in the solar cell production, and a material handling system controller (e.g., PLC or standard computer) that deals with the higher level strategic movement, scheduling and running of the complete solar cell production line.

In one embodiment, the system controller includes local controllers disposed in inspection modules to map and evaluate defects detected in each substrate as it passes through the production line 200 and determine whether to allow the substrate to proceed or reject the substrate for corrective processing or scrapping.

A substrate 302 is loaded into the loading module 202 found in the solar cell production line 200. In one embodiment, the substrates 302 are received in a “raw” state where the edges, overall size, and/or cleanliness of the substrates 302 are not well controlled. Receiving “raw” substrates 302 reduces the cost to prepare and store substrates 302 prior to forming a solar device and thus reduces the solar cell device cost, facilities costs, and production costs of the finally formed solar cell device. However, typically, it is advantageous to receive “raw” substrates 302 that have a transparent conducting oxide (TCO) layer (e.g., first TCO layer 310) already deposited on a surface of the substrate 302 before it is received into the system. If a conductive layer, such as TCO layer, is not deposited on the surface of the “raw” substrates then a front contact deposition step, which is discussed below, needs to be performed on a surface of the substrate 302.

In one embodiment, the substrates 302 are loaded into the solar cell production line 200 in a sequential fashion. The substrate is inserted into a front end substrate seaming module 204 that is used to prepare the edges of the substrate 302 to reduce the likelihood of damage, such as chipping or particle generation from occurring during the subsequent processes. Damage to the substrate 302 can affect device yield and the cost to produce a usable solar cell device. In one embodiment, the front end seaming module 204 is used to round or bevel the edges of the substrate 302. In one embodiment, a diamond impregnated belt or disc is used to grind the material from the edges of the substrate 302. In another embodiment, a grinding wheel, grit blasting, or laser ablation technique is used to remove the material from the edges of the substrate 302.

Next the substrate 302 is transported to the cleaning module 205, in which a substrate cleaning step is performed on the substrate 302 to remove any contaminants found on the surface of thereof. Common contaminants may include materials deposited on the substrate 302 during the substrate forming process (e.g., glass manufacturing process) and/or during shipping or storing of the substrates 302. Typically, the cleaning module 205 uses wet chemical scrubbing and rinsing steps to remove any undesirable contaminants.

In one example, the process of cleaning the substrate 302 may occur as follows. First, the substrate 302 enters a contaminant removal section of the cleaning module 205 from either a transfer table or an automation device 281. In general, the system controller 290 establishes the timing for each substrate 302 that enters the cleaning module 205. The contaminant removal section may utilize dry cylindrical brushes in conjunction with a vacuum system to dislodge and extract contaminants from the surface of the substrate 302. Next, a conveyor within the cleaning module 205 transfers the substrate 302 to a pre-rinse section, where spray tubes dispense hot DI water at a temperature, for example, of 50° C. from a DI water heater onto a surface of the substrate 302. Commonly, since the device substrate has a TCO layer disposed thereon, and since TCO layers are generally electron absorbing materials, DI water is used to avoid any traces of possible contamination and ionizing of the TCO layer. Next, the rinsed substrate 302 enters a wash section. In the wash section, the substrate 302 is wet-cleaned with a brush (e.g., perlon) and hot water. In some cases a detergent (e.g., Alconox™, Citrajet™, Detojet™, Transene™, and Basic H™), surfactant, pH adjusting agent, and other cleaning chemistries are used to clean and remove unwanted contaminants and particles from the substrate surface. A water re-circulation system recycles the hot water flow. Next, in a final rinse section of the cleaning module 205, the substrate 302 is rinsed with water at ambient temperature to remove any traces of contaminants. Finally, in a drying section, an air blower is used to dry the substrate 302 with hot air. In one configuration a deionization bar is used to remove the electrical charge from the substrate 302 at the completion of the drying process.

Next, the substrate 302 is inspected via an inspection module 206, and metrology data is collected and sent to the system controller 290. In one embodiment, the substrate 302 is optically inspected for defects, such as chips, cracks, inclusions, bubbles, or scratches that may inhibit performance of a fully formed solar cell device, such as the solar cell 300a or 300b.

In one embodiment, the substrate 302 is passed through the inspection module 206 via the automation device 281. In one embodiment, as the substrate 302 passes through the inspection module 206, the substrate 302 is optically inspected, and images of the substrate 302 are captured and sent to the system controller 290, where the images are analyzed and metrology data is collected and stored in memory.

In one embodiment, the images captured by the inspection module 206 are analyzed by the system controller 290 and analyzed to determine whether the substrate 302 meets specified quality criteria. If the specified quality criteria are met, the substrate 302 continues on its path in the production line 200. However, if the specified criteria are not met, actions may be taken to either repair the defect or reject the defective substrate 302. In one embodiment, defects detected in the substrate 302 are mapped and analyzed in a portion of the system controller 290 disposed locally within the inspection module 206. In this embodiment, the decision to reject a particular substrate 302 may be made locally within the inspection module 206.

In one embodiment, the system controller 290 may compare information regarding the size of a crack on an edge of a substrate 302 with a specified allowable crack length to determine whether the substrate 302 is acceptable for continued processing in the production line 200. In one embodiment, a crack of about 1 mm or smaller is acceptable. Other criteria that the system controller may compare include the size of a chip in the edge of the substrate 302 or the size of an inclusion or bubble in the substrate 302. In one embodiment, a chip of about 5 mm or less may be acceptable, and an inclusion or bubble of less than about 1 mm may be acceptable. In determining whether to allow continued processing or reject each particular substrate 302, the system controller may apply a weighting scheme to the defects mapped in particular regions of the substrate. For instance, defects detected in critical areas, such as edge regions of the substrate 302, may be given significantly greater weighting than defects found in less critical areas.

In one embodiment, the system controller 290 collects and analyzes the metrology data received from the inspection module 206 for use in determining the root cause of recurring defects in the substrate 302 so that it can correct or tune the preceding processes to eliminate the recurring defects. In one embodiment, the system controller 290 locally maps the defects detected in each substrate 302 for use in a manual or automated metrology data analysis performed by the user or system controller 290.

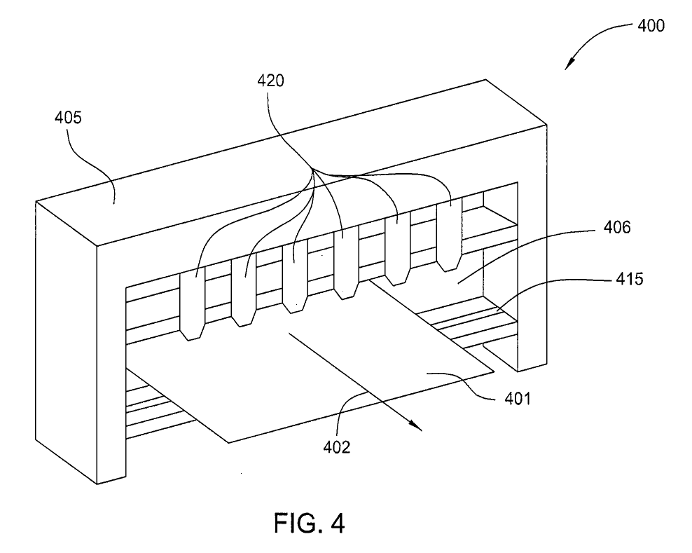

In one embodiment, the inspection module 206 may be similar to the inspection module described in FIG. 4.

Next, separate cells are electrically isolated from one another via scribing processes. Contamination particles on the TCO surface and/or on the bare glass surface can interfere with the scribing procedure. In laser scribing, for example, if the laser beam runs across a particle, it may be unable to scribe a continuous line, and a short circuit between cells will result. In addition, any particulate debris present in the scribed pattern and/or on the TCO of the cells after scribing can cause shunting and non-uniformities between layers. Therefore, a well-defined and well-maintained process is generally needed to ensure that contamination is removed throughout the production process. In one embodiment, the cleaning module 205 is available from the Energy and Environment Solutions division of Applied Materials in Santa Clara, Calif.

Next the device substrate is transported to the scribe module 208 in which a front contact isolation step is performed on the device substrate to electrically isolate different regions of the device substrate surface from each other. Material is removed from the device substrate surface by use of a material removal step, such as a laser ablation process. The success criteria for contact isolation step are to achieve good cell-to-cell and cell-to-edge isolation while minimizing the scribe area. In one embodiment, a Nd:vanadate (Nd:YVO₄) laser source is used ablate material from the device substrate surface to form lines that electrically isolate one region of the device substrate from the next. In one embodiment, the laser scribe process uses a 1064 nm wavelength pulsed laser to pattern the material disposed on the substrate 302 to isolate each of the individual cells that make up the solar cell. In one embodiment, a 5.7 m² substrate laser scribe module available from Applied Materials, Inc. of Santa Clara, Calif. is used to provide simple reliable optics and substrate motion for accurate electrical isolation of regions of the device substrate surface. In another embodiment, a water jet cutting tool or diamond scribe is used to isolate the various regions on the surface of the device substrate. In one aspect, it is desirable to assure that the temperature of the device substrates 302 entering the scribe module 208 are at a temperature in a range between about 20° C. and about 26° C. by use of an active temperature control hardware assembly that may contain a resistive heater and/or chiller components (e.g., heat exchanger, thermoelectric device). In one embodiment, it is desirable to control the device substrate temperature to about 25+/−0.5° C.

Next, the device substrate is transported to an inspection module 209 in which a front contact isolation inspection step is performed on the device substrate to assure the quality of the front contact isolation step. The collected metrology data is then sent and stored within the system controller 290.

In one embodiment, the device substrate is passed through the inspection module 209 via the automation device 281. As the device substrate passes through the inspection module 209. The information regarding continuity of the cells may be transmitted to the system controller 290, where the data is collected, analyzed, and stored.

In one embodiment, the information captured by the inspection module 209 is analyzed by the system controller 290 and analyzed to determine whether the device substrate meets specified quality criteria. If the specified quality criteria are met, the device substrate continues on its path in the production line 200. However, if the specified criteria are not met, actions may be taken to either repair the defect or reject the defective device substrate. In one embodiment, defects detected in the device substrate are captured and analyzed in a portion of the system controller 290 disposed locally within the inspection module 209. In this embodiment, the decision to reject a particular device substrate may be made locally within the inspection module 209.

In one embodiment, if the information provided to the system controller 290 from the inspection module 209 indicates continuity between two adjacent cells, the device substrate may be rejected and sent back through the scribe module 208 for corrective action. In one embodiment, the inspection module 209 may be incorporated within the scribe module 208 so that any areas of continuity between adjacent cells may be discovered and corrected before leaving the scribe module 208.

In one embodiment, the system controller 290 collects and analyzes the metrology data received from the inspection module 209 for use in determining the root cause of recurring defects in the device substrate and correcting or tuning the front contact isolation step or other preceding processes, such as the substrate cleaning step, to eliminate the recurring defects. In one embodiment, the system controller 290 uses the collected data to map the defects detected in each device substrate for use in metrology data analysis.

Next the device substrate is transported to the cleaning module 210 in which a pre-deposition substrate cleaning is performed on the device substrate to remove any contaminants found on the surface of the device substrate. Typically, the cleaning module 210 uses wet chemical scrubbing and rinsing steps to remove any undesirable contaminants found on the device substrate surface after performing the cell isolation step.

Next, the device substrate is transported to the processing module 212 in which one or more photoabsorber deposition is performed on the device substrate. The one or more photoabsorber deposition may include one or more preparation, etching, and/or material deposition steps that are used to form the various regions of the solar cell device. The photoabsorber deposition generally comprises a series of sub-processing steps that are used to form one or more p-i-n junctions. In one embodiment, the one or more p-i-n junctions comprise amorphous silicon and/or microcrystalline silicon materials. In general, the one or more processing steps are performed in one or more cluster tools (e.g., cluster tools 212A-212D) found in the processing module 212 to form one or more layers in the solar cell device formed on the device substrate. In one embodiment, the device substrate is transferred to an accumulator 211A prior to being transferred to one or more of the cluster tools 212A-212D. In one embodiment, in cases where the solar cell device is formed to include multiple junctions, such as the tandem junction solar cell 300b illustrated in FIG. 1B, the cluster tool 212A in the processing module 212 is adapted to form the first p-i-n junction 320 and cluster tools 212B-212D are configured to form the second p-i-n junction 330.

In one embodiment of the process sequence, a cool down step is performed after photoabsorber deposition has been performed. The cool down step is generally used to stabilize the temperature of the device substrate to assure that the processing conditions seen by each device substrate in the subsequent processing steps are repeatable. Generally, the temperature of the device substrate exiting the processing module 212 could vary by many degrees Celsius and exceed a temperature of 50° C., which can cause variability in the subsequent processing steps and solar cell performance.

In one embodiment, the cool down step is performed in one or more of the substrate supporting positions found in one or more accumulators 211. In one configuration of the production line, as shown in FIG. 2, the processed device substrates 302 may be positioned in one of the accumulators 211B for a desired period of time to control the temperature of the device substrate. In one embodiment, the system controller 290 is used to control the positioning, timing, and movement of the device substrates 302 through the accumulator(s) 211 to control the temperature of the device substrates 302 before proceeding down stream through the production line.

Next, the deposited film is inspected via an inspection module 214, and metrology data is collected and sent to the system controller 290. In one embodiment, the device substrate is optically inspected for defects in the film layers deposited, such as pinholes, that may create a short between the first TCO layer 310 and the back contact layer 350 of a fully formed solar cell device, such as the solar cell 300a or 300b.

In one embodiment, the device substrate is passed through the inspection module 214 via the automation device 281. As the device substrate passes through the inspection module 214, the device substrate is optically inspected, and images of the substrate 302 are captured and sent to the system controller 290, where the images are analyzed and metrology data is collected.

In one embodiment, the images captured by the inspection module 214 are analyzed by the system controller 290 and analyzed to determine whether the device substrate meets specified quality criteria. If the specified quality criteria are met, the device substrate continues on its path in the production line 200. However, if the specified criteria are not met, actions may be taken to either repair the defect or reject the defective device substrate. In one embodiment, defects detected in the device substrate are captured and analyzed in a portion of the system controller 290 disposed locally within the inspection module 214. In this embodiment, the decision to reject a particular device substrate may be made locally within the inspection module 214.

In one embodiment, the system controller 290 may compare information received from the inspection module 214 with programmed data to determine whether a detected film defect is pinhole extending through all of the film layers deposited or whether the detected film defect is a partial pinhole extending through only one or two of the deposited film layers. If the system controller 290 determines that the pinhole extends through all of the layers and is of a size and/or quantity exceeding specified criteria, corrective action may be taken, such as removing the device substrate for manual inspection or scrapping the device substrate. If the system controller 290 determines that the pinhole is a partial pinhole or that any pinholes detected are not of a size or quantity exceeding specified criteria, the device substrate is transported out of the inspection module 214 for further processing in the production line 200.

In one embodiment, the system controller 290 collects and analyzes the metrology data received from the inspection module 214 for use in determining the root cause of recurring defects in the device substrate and correcting or tuning the preceding processes to eliminate the recurring defects. For instance, if the system controller 290 determines partial pinholes are recurring in a specific film layer, the system controller 290 may signal that a particular chamber in the processing module 212 may be contaminated, and the contaminated chamber may be taken offline to correct the problem without shutting down the entire production line. In another instance, the system controller may indicate that clean room filters or blowers may be contaminated and need cleaning or replacement. In one embodiment, the system controller 290 maps the defects detected in each device substrate, either locally or centrally, for use in metrology data analysis.

One embodiment of an optical inspection module, such as the inspection module 214, is subsequently described in more detail in the section entitled, “Optical Inspection Module.”

Next, the device substrate is inspected via an inspection module 215 and metrology data is collected and sent to the system controller 290. In one embodiment, the device substrate is spectrographically inspected to determine certain characteristics of the film deposited onto the device substrate, such as the variation in film thickness across the surface of the device substrate and the band gap of the films deposited onto the device substrate.

In one embodiment, the device substrate is passed through the inspection module 215 via the automation device 281. As the device substrate passes through the inspection module 215, the device substrate is spectrographically inspected, and images of the substrate 302 are captured and sent to the system controller 290, where the images are analyzed and metrology data is collected and stored.

In one embodiment, the inspection module 215 is an inspection strip located below or above the device substrate as it is transported by an automation device 281. In one embodiment, the inspection module 215 is configured to determine the exact positioning and velocity of the device substrate as it passes therethrough. Thus, all data acquired from the inspection module 215 as a time series may be placed within a reference frame of the device substrate. With this information, parameters such as uniformity of film thickness across the surface of the device substrate may be determined and sent to the system controller 290 for collection and analysis.

In one embodiment, the data received by the system controller 290 from the inspection module 215 are analyzed by the system controller 290 and compared analyzed to determine whether the device substrate meets specified quality criteria. If the specified quality criteria are met, the device substrate continues on its path in the production line 200. However, if the specified criteria are not met, actions may be taken to either repair the defect or reject the defective device substrate. In one embodiment, data collected by the inspection module 214 is captured and analyzed in a portion of the system controller 290 disposed locally within the inspection module 215. In this embodiment, the decision to reject a particular device substrate may be made locally within the inspection module 215.

In one embodiment, the system controller 290 may analyze the information received from the inspection module 215 to characterize the device substrate regarding certain film parameters. In one embodiment, the thickness and variation in thickness across the surface of the device substrates may be measured and analyzed to monitor and tune the process parameters in the film deposition step. In one embodiment, the band gap of the deposited film layers on the device substrates 302 may be measured and analyzed to monitor and tune the process parameters in the film deposition step as well.

In one embodiment, the system controller 290 collects and analyzes the metrology data received from the inspection module 215 for use in determining the root cause of recurring defects in the device substrate and correcting or tuning the preceding processes to eliminate the recurring defects. For instance, if the system controller 290 determines deficiencies in the film thickness are recurring in a specific film layer, the system controller 290 may signal that the process recipe for a specific process may need to be refined. As a result the process recipe may be automatically or manually refined to ensure that the completed solar cell devices meet desired performance criteria.

Next, the device substrate is transported to the scribe module 216 and an interconnect formation step is performed on the device substrate to electrically isolate various regions of the device substrate surface from each other. Material is removed from the device substrate surface by use of a material removal step, such as a laser ablation process. In one embodiment, an Nd:vanadate (Nd:YVO₄) laser source is used ablate material from the substrate surface to form lines that electrically isolate one solar cell from the next. In one embodiment, a 5.7 m² substrate laser scribe module available from Applied Materials, Inc. is used to perform the accurate scribing process. In one embodiment, the laser scribe process performed during contact isolation step uses a 532 nm wavelength pulsed laser to pattern the material disposed on the device substrate to isolate the individual cells that make up the solar cell. In one embodiment, the trench is formed in the first p-i-n junction 320 layers by used of a laser scribing process. In another embodiment, a water jet cutting tool or diamond scribe is used to isolate the various regions on the surface of the solar cell. In one aspect, it is desirable to assure that the temperature of the device substrates 302 entering the scribe module 216 are at a temperature in a range between about 20° C. and about 26° C. by use of an active temperature control hardware assembly that may contain a resistive heater and/or chiller components (e.g., heat exchanger, thermoelectric device). In one embodiment, it is desirable to control the substrate temperature to about 25+/−0.5° C.

In one embodiment, the solar cell production line 200 has at least one accumulator 211 positioned after the scribe module(s) 216. During production accumulators 211C may be used to provide a ready supply of substrates to the processing module 218, and/or provide a collection area where substrates coming from the processing module 212 can be stored if the processing module 218 goes down or can not keep up with the throughput of the scribe module(s) 216. In one embodiment it is generally desirable to monitor and/or actively control the temperature of the substrates exiting the accumulators 211C to assure that the results of the back contact formation step are repeatable. In one aspect, it is desirable to assure that the temperature of the substrates exiting the accumulators 211C or arriving at the processing module 218 are at a temperature in a range between about 20° C. and about 26° C. In one embodiment, it is desirable to control the substrate temperature to about 25+/−0.5° C. In one embodiment, it is desirable to position one or more accumulators 211C that are able to retain at least about 80 substrates.

Next, the device substrate is transported to the processing module 218 in which one or more substrate back contact formation steps are performed on the device substrate. The one or more substrate back contact formation steps may include one or more preparation, etching, and/or material deposition steps that are used to form the back contact regions of the solar cell device. In one embodiment, a contact formation step generally comprises one or more PVD steps that are used to form the back contact layer 350 on the surface of the device substrate. In one embodiment, the one or more PVD steps are used to form a back contact region that contains a metal layer selected from a group consisting of zinc (Zn), tin (Sn), aluminum (Al), copper (Cu), silver (Ag), nickel (Ni), and vanadium (V). In one example, a zinc oxide (ZnO) or nickel vanadium alloy (NiV) is used to form at least a portion of the back contact layer. In one embodiment, the one or more processing steps are performed using an ATON™ PVD 5.7 tool available from Applied Materials in Santa Clara, Calif. In another embodiment, one or more CVD steps are used to form the back contact layer 350 on the surface of the device substrate.

In one embodiment, the solar cell production line 200 has at least one accumulator 211 positioned after the processing module 218. During production, the accumulators 211D may be used to provide a ready supply of substrates to the scribe modules 220, and/or provide a collection area where substrates coming from the processing module 218 can be stored if the scribe modules 220 go down or can not keep up with the throughput of the processing module 218. In one embodiment it is generally desirable to monitor and/or actively control the temperature of the substrates exiting the accumulators 211D to assure that the results of the back contact formation step are repeatable. In one aspect, it is desirable to assure that the temperature of the substrates exiting the accumulators 211D or arriving at the scribe module 220 is at a temperature in a range between about 20° C. and about 26° C. In one embodiment, it is desirable to control the substrate temperature to about 25+/−0.5° C. In one embodiment, it is desirable to position one or more accumulators 211C that are able to retain at least about 80 substrates.

Next, the device substrate is transported to the scribe module 220 and a back contact isolation step is performed on the device substrate to electrically isolate the plurality of solar cells contained on the substrate surface from each other. In the back contact isolation step, material is removed from the substrate surface by use of a material removal step, such as a laser ablation process. In one embodiment, a Nd:vanadate (Nd:YVO₄) laser source is used ablate material from the device substrate surface to form lines that electrically isolate one solar cell from the next. In one embodiment, a 5.7 m² substrate laser scribe module, available from Applied Materials, Inc., is used to accurately scribe the desired regions of the device substrate. In one embodiment, the laser scribe process performed uses a 532 nm wavelength pulsed laser to pattern the material disposed on the device substrate to isolate the individual cells that make up the solar cell. In one embodiment, the trench is formed in the first p-i-n junction 320 and back contact layer 350 by use of a laser scribing process. In one aspect, it is desirable to assure that the temperature of the device substrates 302 entering the scribe module 220 are at a temperature in a range between about 20° C. and about 26° C. by use of an active temperature control hardware assembly that may contain a resistive heater and/or chiller components (e.g., heat exchanger, thermoelectric device). In one embodiment, it is desirable to control the substrate temperature to about 25+/−0.5° C.

Next, the device substrate is transported to the quality assurance module 222 in which quality assurance and/or shunt removal steps are performed on the device substrate to assure that the devices formed on the substrate surface meet a desired quality standard and in some cases correct defects in the formed device. A probing device is used to measure the quality and material properties of the formed solar cell device by use of one or more substrate contacting probes. In one embodiment, the quality assurance module 222 projects a low level of light at the p-i-n junction(s) of the solar cell and uses the one more probes to measure the output of the cell to determine the electrical characteristics of the formed solar cell device(s). If the module detects a defect in the formed device, it can take corrective actions to fix the defects in the formed solar cells on the device substrate. In one embodiment, if a short or other similar defect is found, it may be desirable to create a reverse bias between regions on the substrate surface to control and or correct one or more of the defectively formed regions of the solar cell device. During the correction process the reverse bias generally delivers a voltage high enough to cause the defects in the solar cells to be corrected. In one example, if a short is found between supposedly isolated regions of the device substrate the magnitude of the reverse bias may be raised to a level that causes the conductive elements in areas between the isolated regions to change phase, decompose, or become altered in some way to eliminate or reduce the magnitude of the electrical short. In one embodiment of the process sequence, the quality assurance module 222 and factory automation system are used together to resolve quality issues found in a formed device substrate during the quality assurance testing. In one case, a device substrate may be sent back upstream in the processing sequence to allow one or more of the fabrication steps to be re-performed on the device substrate (e.g., back contact isolation step) to correct one or more quality issues with the processed device substrate.

Next, the device substrate is optionally transported to the substrate sectioning module 224 in which a substrate sectioning step is used to cut the device substrate into a plurality of smaller device substrates 302 to form a plurality of smaller solar cell devices. In one embodiment, the device substrate is inserted into substrate sectioning module 224 that uses a CNC glass cutting tool to accurately cut and section the device substrate to form solar cell devices that are a desired size. In one embodiment, the device substrate is inserted into the sectioning module 224 that uses a glass scribing tool to accurately score the surface of the device substrate. The device substrate is then broken along the scored lines to produce the desired size and number of sections needed for the completion of the solar cell devices.

In one embodiment, the solar cell production line 200 is adapted to accept and process substrate 302 or device substrates 302 that are 5.7 m² or larger. In one embodiment, these large area substrates 302 are partially processed and then sectioned into four 1.4 m² device substrates 302 during substrate separation step. In one embodiment, the system is designed to process large device substrates 302 (e.g., TCO coated 2200 mm×2600 mm×3 mm glass) and produce various sized solar cell devices without additional equipment or processing steps. Currently amorphous silicon (a-Si) thin film factories must have one product line for each different size solar cell device. In the present invention, the manufacturing line is able to quickly switch to manufacture different solar cell device sizes. In one aspect of the invention, the manufacturing line is able to provide a high solar cell device throughput, which is typically measured in Mega-Watts per year, by forming solar cell devices on a single large substrate and then sectioning the substrate to form solar cells of a more preferable size.

In one embodiment of the production line 200, the front end of the line (FEOL) is designed to process a large area device substrate (e.g., 2200 mm×2600 mm), and the back end of the line (BEOL) is designed to further process the large area device substrate or multiple smaller device substrates 302 formed by use of the sectioning process. In this configuration, the remainder of the manufacturing line accepts and further processes the various sizes. The flexibility in output with a single input is unique in the solar thin film industry and offers significant savings in capital expenditure. The material cost for the input glass is also lower since solar cell device manufacturers can purchase a larger quantity of a single glass size to produce the various size modules.

Next, the device substrate is transported to the seamer/edge deletion module 226 in which a substrate surface and edge preparation step is used to prepare various surfaces of the device substrate to prevent yield issues later on in the process. In one embodiment, the device substrate is inserted into seamer/edge deletion module 226 to prepare the edges of the device substrate to shape and prepare the edges of the device substrate. Damage to the device substrate edge can affect the device yield and the cost to produce a usable solar cell device. In another embodiment, the seamer/edge deletion module 226 is used to remove deposited material from the edge of the device substrate (e.g., 10 mm) to provide a region that can be used to form a reliable seal between the device substrate and the backside glass. Material removal from the edge of the device substrate may also be useful to prevent electrical shorts in the final formed solar cell.

In one embodiment, a diamond impregnated belt is used to grind the deposited material from the edge regions of the device substrate. In another embodiment, a grinding wheel is used to grind the deposited material from the edge regions of the device substrate. In another embodiment, dual grinding wheels are used to remove the deposited material from the edge of the device substrate. In yet another embodiment, grit blasting or laser ablation techniques are used to remove the deposited material from the edge of the device substrate. In one aspect, the seamer/edge deletion module 226 is used to round or bevel the edges of the device substrate by use of shaped grinding wheels, angled and aligned belt sanders, and/or abrasive wheels.

Next the device substrate is transported to the pre-screen module 227 in which optional pre-screen steps are performed on the device substrate to assure that the devices formed on the substrate surface meet a desired quality standard. A light emitting source and probing device are used to measure the output of the formed solar cell device by use of one or more substrate contacting probes. If the module 227 detects a defect in the formed device it can take corrective actions or the solar cell can be scrapped.

Next the device substrate is transported to the cleaning module 228 in which a pre-lamination substrate cleaning step is performed on the device substrate to remove any contaminants found on the surface of the substrates 302 after performing previous steps. Typically, the cleaning module 228 uses wet chemical scrubbing and rinsing steps to remove any undesirable contaminants found on the substrate surface after performing the cell isolation step.

In the next step, the device substrate is inspected via an inspection module 229, and metrology data is collected and sent to the system controller 290. In one embodiment, the device substrate is optically inspected for defects, such as chips, cracks, or scratches that may inhibit performance of a fully formed solar cell device, such as the solar cell 300a or 300b.

In one embodiment, the device substrate passes through the inspection module 229 by use of an automation device 281. As the device substrate passes through the inspection module 229, the device substrate is optically inspected, and images of the device substrate are captured and sent to the system controller 290, where the images are analyzed and metrology data is collected and stored.

In one embodiment, the images captured by the inspection module 229 are analyzed by the system controller 290 and analyzed to determine whether the device substrate meets specified quality criteria. If the specified quality criteria are met, the device substrate continues on its path in the production line 200. However, if the specified criteria are not met, actions may be taken to either repair the defect or reject the defective device substrate. In one embodiment, defects detected in the device substrate are mapped and analyzed in a portion of the system controller 290 disposed locally within the inspection module 229. In this embodiment, the decision to reject a particular device substrate may be made locally within the inspection module 206.

In one example, the system controller 290 may compare information regarding the size of a crack on an edge of a device substrate with a specified allowable crack length to determine whether the substrate 302 should continue being processed in the production line 200. In one embodiment, a crack of about 1 mm or smaller is acceptable. Other criteria that the system controller may compare include the size of a chip in the edge of the device substrate. In one embodiment, a chip of about 5 mm or less is acceptable. In determining whether to allow continued processing or reject each particular substrate 302, the system controller may apply a weighting scheme to the defects mapped in particular regions of the substrate. For instance, defects detected in critical areas, such as edge regions of the device substrate, may be given significantly greater weighting than defects found in less critical areas.

In one embodiment, the system controller 290 collects and analyzes the metrology data received from the inspection module 229 for use in determining the root cause of recurring defects in the device substrate so that it can correct or tune the preceding processes, such as substrate sectioning step or edge preparation step, to eliminate the recurring defects. In one embodiment, the system controller 290 maps the defects detected in each device substrate, either locally or centrally, for use in metrology data analysis.

One embodiment of an optical inspection module, such as the inspection module 229 is subsequently described in more detail in the section entitled, “Optical Inspection Module.”

In the next step, each device substrate is inspected via an inspection module 230, and metrology data is collected and sent to the system controller 290. In one embodiment, edges of the device substrate are inspected via an optical interferometry technique to detect any residues in the edge deletion area that may create shorts or paths in which the external environment can attack portions of a fully formed solar cell device, such as the solar cell 300a or 300b.

In one embodiment, the device substrate is passed through the inspection module 230 via an automation device 281. As the device substrate passes through the inspection module 230, edge deletion regions of the device substrate are interferometrically inspected, and information obtained from the inspection is sent to the system controller 290 for collection and analysis.

In one embodiment, the inspection module 230 determines the surface profile of the device substrate in the edge deletion area. A portion of the system controller 290 disposed locally within the inspection module 230 may analyze the surface profile data collected to assure that edge deletion area profile is within a desired range. If the specified profile criteria are met, the device substrate continues on its path in the production line 200. However, if the specified profile criteria are not met, actions may be taken to either repair the defect or reject the defective device substrate.

In one example, the system controller 290, either locally or centrally, may compare information regarding the height of the edge deletion region of the device substrate with a specified height range to determine whether the device substrate is acceptable for continued processing in the production line 200. In one embodiment, if the edge deletion region height is determined to be too great in a particular region, the device substrate may be sent back to the seamer/edge deletion module 226 for repair in the edge-preparation step. In one embodiment, if the edge profile is not at least about 10 μm lower than the front surface of the device substrate, the device substrate is rejected for reprocessing, such as the edge preparation process, or scrapping.

In one embodiment, the system controller 290 collects, analyzes, and stores the metrology data received from the inspection module 229 for use in determining the root cause of recurring defects in the device substrate and correct or tune the preceding edge preparation processes to eliminate the recurring defects. In one embodiment, the data collected by the inspection module 229 may indicate that maintenance or part replacement is needed in an upstream module, such as the seamer/edge deletion module 226.

Next the substrate 302 is transported to a bonding wire attach module 231 in which a bonding wire attach step, is performed on the substrate 302. The boding wire attach step is used to attach the various wires/leads required to connect the various external electrical components to the formed solar cell device. Typically, the bonding wire attach module 231 is an automated wire bonding tool that is advantageously used to reliably and quickly form the numerous interconnects that are often required to form the large solar cells formed in the production line 200. In one embodiment, the bonding wire attach module 231 is used to form the side-buss and cross-buss on the formed back contact region. In this configuration the side-buss may be a conductive material that can be affixed, bonded, and/or fused to the back contact layer 350 found in the back contact region to form a good electrical contact. In one embodiment, the side-buss and cross-buss each comprise a metal strip, such as copper tape, a nickel coated silver ribbon, a silver coated nickel ribbon, a tin coated copper ribbon, a nickel coated copper ribbon, or other conductive material that can carry the current delivered by the solar cell and be reliably bonded to the metal layer in the back contact region. In one embodiment, the metal strip is between about 2 mm and about 10 mm wide and between about 1 mm and about 3 mm thick. The cross-buss, which is electrically connected to the side-buss at the junctions, can be electrically isolated from the back contact layer(s) of the solar cell by use of an insulating material, such as an insulating tape. The ends of each of the cross-busses generally have one or more leads that are used to connect the side-buss and the cross-buss to the electrical connections found in a junction box, which is used to connect the formed solar cell to the other external electrical components.

In the next step, a bonding material and “back glass” substrate are prepared for delivery into the solar cell formation process. The preparation process is generally performed in the glass lay-up module 232, which generally comprises a material preparation module 232A, a glass loading module 232B, a glass cleaning module 232C, and a glass inspection module 232D. The back glass substrate is bonded onto the device substrate formed in steps above by use of a laminating process. In general, the preparation process requires the preparation of a polymeric material that is to be placed between the back glass substrate and the deposited layers on the device substrate to form a hermetic seal to prevent the environment from attacking the solar cell during its life.

In the next step, the back glass substrate is transported to the cleaning module 232C in which a substrate cleaning step, is performed on the substrate to remove any contaminants found on the surface of the substrate. Common contaminants may include materials deposited on the substrate during the substrate forming process (e.g., glass manufacturing process) and/or during shipping of the substrates 361. Typically, the cleaning module 232C uses wet chemical scrubbing and rinsing steps to remove any undesirable contaminants as discussed above.

Next, the back glass substrate is inspected via the inspection module 232D, and metrology data is collected and sent to the system controller 290. In one embodiment, the back glass substrate is optically inspected for defects, such as chips, cracks, or scratches that may inhibit performance of a fully formed solar cell device, such as the solar cell 300a or 300b.

Next the device substrate, the back glass substrate, and the bonding material are transported to the bonding module 234 in which lamination steps are performed to bond the backside glass substrate to the device substrate formed in steps discussed above. In the lamination steps, a bonding material, such as Polyvinyl Butyral (PVB) or Ethylene Vinyl Acetate (EVA), is sandwiched between the backside glass substrate and the device substrate. Heat and pressure are applied to the structure to form a bonded and sealed device using various heating elements and other devices found in the bonding module 234. The device substrate, the back glass substrate and bonding material thus form a composite solar cell structure that at least partially encapsulates the active regions of the solar cell device. In one embodiment, at least one hole formed in the back glass substrate remains at least partially uncovered by the bonding material to allow portions of the cross-buss or the side buss to remain exposed so that electrical connections can be made to these regions of the solar cell structure in future steps.

Next the composite solar cell structure is transported to the autoclave module 236 in which autoclave steps are performed on the composite solar cell structure to remove trapped gasses in the bonded structure and assure that a good bond is formed during bonding/lamination step. In the autoclave step, a bonded solar cell structure is inserted in the processing region of the autoclave module where heat and high pressure gases are delivered to reduce the amount of trapped gas and improve the properties of the bond between the device substrate, back glass substrate, and bonding material. The processes performed in the autoclave are also useful to assure that the stress in the glass and bonding layer (e.g., PVB layer) are more controlled to prevent future failures of the hermetic seal or failure of the glass due to the stress induced during the bonding/lamination process. In one embodiment, it may be desirable to heat the device substrate, back glass substrate, and bonding material to a temperature that causes stress relaxation in one or more of the components in the formed solar cell structure.

Next, the composite solar cell structure is inspected via an inspection module 237, and metrology data is collected and sent to the system controller 290. In one embodiment, the composite solar cell structure is optically inspected for defects, such as chips, cracks, inclusions, bubbles, or scratches that may inhibit performance of a fully formed solar cell device, such as the solar cell 300a or 300b.

In one embodiment, the composite solar cell structure is passed through the inspection module 237 by use of an automation device 281. As the composite solar cell structure passes through the inspection module 237, the composite solar cell structure is optically inspected, and images of the composite solar cell structure are captured and sent to the system controller 290, where the images are analyzed and metrology data is collected and stored.

Next the solar cell structure is transported to the junction box attachment module 238 in which junction box attachment steps are performed on the formed solar cell structure. The junction box attachment module 238 is used to install a junction box on a partially formed solar cell. The installed junction box acts as an interface between the external electrical components that will connect to the formed solar cell, such as other solar cells or a power grid, and the internal electrical connections points.

Next the solar cell structure is transported to the device testing module 240 in which device screening and analysis steps are performed on the solar cell structure to assure that the devices formed on the solar cell structure surface meet desired quality standards. In one embodiment, the device testing module 240 is a solar simulator module that is used to qualify and test the output of the one or more formed solar cells. In the screening and analysis steps, a light emitting source and probing device are used to measure the output of the formed solar cell device by use of one or more automated components that are adapted to make electrical contact with terminals in the junction box. If the module detects a defect in the formed device it can take corrective actions or the solar cell can be scrapped.

Next the solar cell structure is transported to the support structure module 241 in which support structure mounting steps are performed on the solar cell structure to provide a complete solar cell device that has one or more mounting elements attached to the solar cell structure formed using previous steps to a complete solar cell device that can easily be mounted and rapidly installed at a customer's site.

Next the solar cell structure is transported to the unload module 242 in which device unload steps are performed on the substrate to remove the formed solar cells from the solar cell production line 200.

In one embodiment of the solar cell production line 200, one or more regions in the production line are positioned in a clean room environment to reduce or prevent contamination from affecting the solar cell device yield and useable lifetime.

As shown in FIG. 2, the solar cell production line 200 may comprise various inspection stations, such as inspection stations 206, 209, 215, 215b, 217, 210, 221 for quality control.

### Optical Inspection Module

As discussed above, embodiments of the present invention provide apparatus and method for detecting pinholes in one or more light absorbing films deposited on a substrate. One embodiment of the present invention provides an inspection station comprising an illumination assembly having a first light source providing light of wavelengths in a first spectrum and a second light source providing light of wavelengths in a second spectrum. The inspection station further comprises an image sensor captures images of the substrate from lights penetrating through the substrate. In one embodiment, the first and second light sources are first and second light emitting diodes (LEDs) alternately disposed along a line and may be turned on and off independently. In one embodiment, the first light source and the second light source are pulsed alternately as the substrate is moving through the inspection while the image sensor captures images from both light sources.

Embodiments of the present invention can obtain two images of a substrate from two light sources without inspecting the substrate twice, or doubling the number of cameras or other sensors, or degrading efficiencies of the light source.

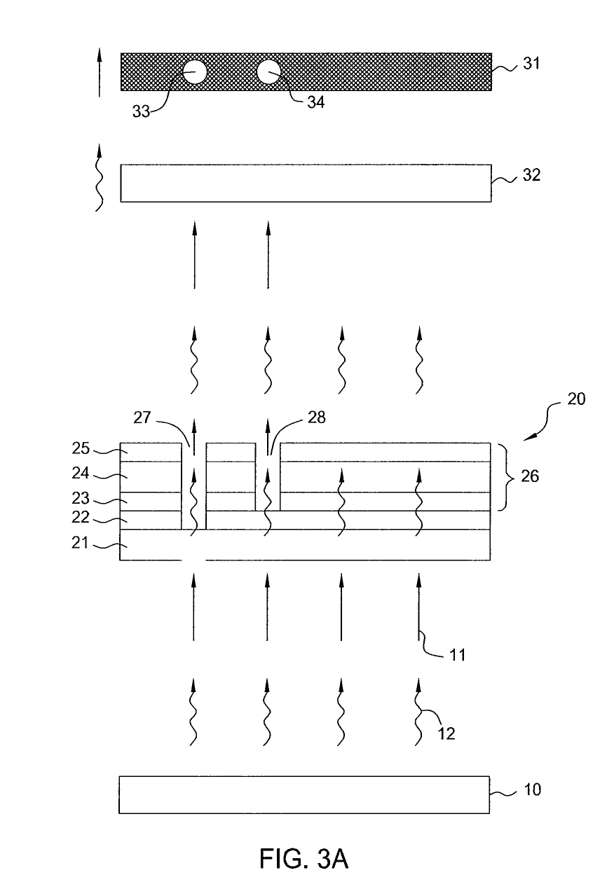

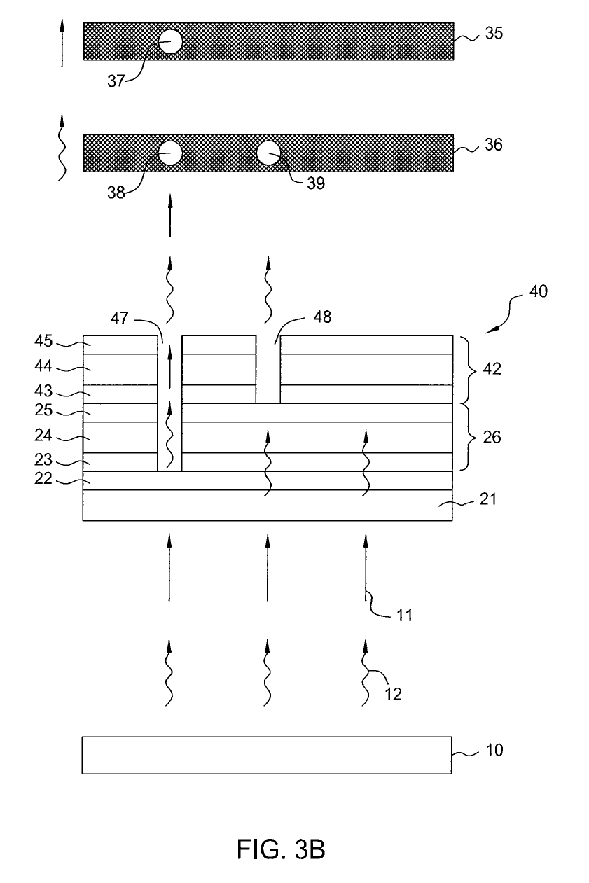

FIG. 3A schematically illustrates a process for substrate inspection in accordance with one embodiment of the present invention. In FIG. 3A, a substrate 20 is being inspected by directing lights from an illumination source 10 towards the substrate 20 and capturing images of the lights shine through the substrate 20. As shown in FIG. 3A, the illumination source 10 may provide light having wavelengths within different spectrums. In one embodiment, the illumination source 10 may alternately provide a first light 11 and a second light 12 in the time domain.

The substrate 20 shown in FIG. 3A having a p-i-n junction 26 formed on a light transparent substrate 21 having a TCO layer 22. In one embodiment, the p-i-n junction 26 may comprise a p-type silicon layer 23, an intrinsic type silicon layer 24 formed over the p-type silicon layer 23, and an n-type silicon layer 25 formed over the intrinsic type silicon layer 24. The p-i-n junction 26 may be formed from amorphous silicon layers or microcrystalline silicon layers. After formation of the p-i-n junction 26, an inspection may be performed to detect defects.

In one embodiment of the present invention, inspection of the p-i-n junction 26 may be performed by directing the first light 11 and the second light consecutively through the p-i-n junction 26, wherein the first light 11 is absorbable by the p-i-n junction 26 and the second light 12 is not absorbable by the p-i-n junction 26.

Optical sensors, such as charge-coupled device (CCD) cameras, may be positioned on an opposite side of the substrate 20 from the illumination source 10. The optical sensors are configured to capture lights that shine through the substrate 20.

In areas on the substrate 20 where the p-i-n junction 26 is properly formed, the first light 11 is absorbed and will not shine through. In areas on the substrate 20, where pinholes 27, 28 exist, the first light 11 will shine through. As a result, pinholes 27, 28 appear to be bright spots 33, 34 in an image 31 captured when the first light 11 is directed to the substrate 20. Since the second light 12 cannot be absorbed by the p-i-n junction 26, an image 32 captured when the second light 12 is directed to the substrate 20 should have no dark spots unless there are particle contaminations present on the substrate 20. Therefore, by capturing and comparing two frames of images 31 and 32, defects in the p-i-n junction 26 can be detected. Pinholes within p-i-n junctions, such as pinholes 27, 28, are shown as bright spots in images captured when absorbable lights shining through the p-i-n junctions. Other defects, such as particles on the substrate, may shown as dark sports in images captured when non-absorbable lights shining through the p-i-n junctions.

In one embodiment, only the first light 11 may be used to detect the pinholes in a single p-i-n junction.

FIG. 3B schematically illustrates a method for substrate inspection in accordance with another embodiment of the present invention.

The inspection process shown in FIG. 3B is similar to the inspection process of FIG. 3A except that a substrate 40 being inspected having a multi-junction solar cell formed thereon. The substrate 40 has a first p-i-n junction 26 and a second p-i-n junction 42 formed over the first p-i-n junction 26. In application, the p-i-n junctions 26 and 42 are configured to absorb light within different spectrums to obtain an overall improved efficiency.

In one embodiment, a first light 11 absorbable by the first p-i-n junction 26 and a second light 12 absorbable by the second p-i-n junction 42 may be projected to the substrate 40 separately and images from each light 11, 12 are taken from opposite side of the light source 10. In one embodiment, the first p-i-n junction 26 may include an amorphous intrinsic silicon film 24 while the second p-i-n junction 42 may include a microcrystalline intrinsic silicon film 44, a p-type silicon layer 43, and a n-type silicon layer 45, and the first light 11 is within the red spectrum and the second light 12 is within the blue spectrum.

Image 35 is captured when the first light 11 shines through the substrate 40 and image 36 is capture when the second light 12 shines through the substrate 40. Pinholes through the first p-i-n junction 26 can be detected as bright spots, such as spot 37, in the image 35. Pinholes through the second p-i-n junction 42 can be detected as bright spots such as spots 38, 39, in the image 36. Whether a pinhole is a through hole, such as pinhole 47, or a half filled hole, such as pinhole 48 may be decided by comparing images 35, 36. By determining whether a pinhole is a through hole or a half filled hole can help to pinpoint the cause of the defect.

The inspection processes shown in FIGS. 3A and 3B may be performed by an optical inspection module 400 in accordance with one embodiment of the present invention as shown in FIG. 4.

The optical inspection module 400 can be used alone or in a processing system. For example, the optical inspection module 400 can be used as one or more of the inspection modules 206, 214, 229, 232D, and 237 in the production line 200 of FIG. 2.

In one embodiment, the optical inspection module 400 comprises a frame structure 405, an illumination source assembly 415, and an image sensor assembly 420 configured to capture light from the illumination source assembly 415. The frame structure 405 may define an opening 406 allowing a substrate 401 passing between the illumination source assembly 415 and the image sensor assembly 420 so that the substrate 401 can be inspected by directing lights through the substrate 401 and capturing images from lights passing through.

In one embodiment, the illumination source assembly 415 is configured to project a line of light across the width of the substrate 401. During inspection, the substrate 401 may move along a direction 402 substantially perpendicular to the illumination source assembly 415 so that the substrate 401 can be inspected line by line.

The illumination source assembly 415 may comprise any type of light source capable of illuminating the substrate 401 for inspection thereof. In one embodiment, the wavelengths of light emitted from the illumination source assembly 415 may be controlled to provide optimum optical inspection conditions.

In one embodiment, the illumination source assembly 415 may emit wavelengths of light in a spectrum that can be absorbed by one or more film being inspected. For example, the illumination source assembly 415 may emit wavelengths of light in the red spectrum in inspecting p-i-n junctions or intrinsic silicon layers formed by amorphous silicon, which absorb lights in the red spectrum.

In one embodiment, the illumination source assembly 415 may emit wavelengths of light in two or more spectrums. For example, the illumination source assembly 415 may emit wavelengths of light in the red spectrum which can be absorbed by p-i-n junctions or intrinsic silicon layers formed by amorphous silicon, and wavelengths of light in the blue spectrum which cannot be absorbed by the amorphous silicon film but can be absorbed by microcrystalline intrinsic silicon layer or microcrystalline intrinsic p-i-n junctions.

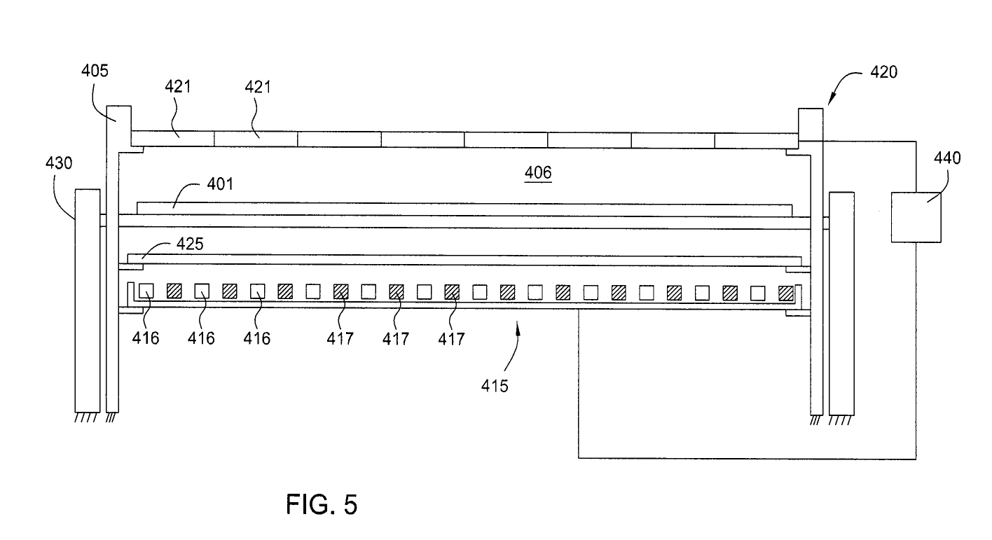

FIG. 5 is a schematic sectional view of the optical inspection module 400 having an illumination source assembly 415 in accordance with one embodiment of the present invention.

The illumination source assembly 415 comprises a plurality of first light emitting diodes (LEDs) 416 configured to emitting light in a first spectrum, and a plurality of second LEDs 417 configured to emitting light in a second spectrum. The first LEDs 416 and the second LEDs are disposed alternately and substantially along line to form line light sources. In one embodiment, the LEDs 416 and 417 are packed as possible to obtain uniform light emission. In one embodiment, the first LEDs 416 emit light in the red spectrum and the second LEDs 417 emits light in the blue spectrum. It should be noted that light sources other than LEDs, such as lasers, can be used by the illumination source assembly 415.

In one embodiment, the illumination source assembly 415 is connected to a controller 440 which controls the first LEDs 416 and the second LEDs 417 and synchronizes the image sensor assembly 420. In one embodiment, the controller 440 may turn on one of the LEDs 416 or 417 for the entire inspection and control the image sensor assembly 420 to capture frames of images according to the speed of the substrate 401. In another embodiment, the controller 440 may turn on one or both of the LEDs 416 and 417 in short pulses and synchronize the image sensor assembly 420 accordingly.

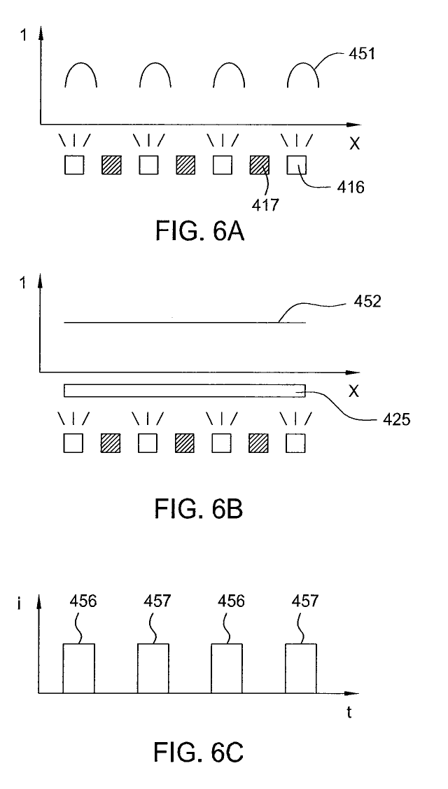

In another embodiment, the controller 440 may turn on the LEDs 416 and 417 for short pulses in an alternate manner and synchronize the image sensor assembly 420 accordingly to capture images of the substrate 401 from both lights emitted by LEDs 416 and the lights emitted by the LEDs 417. FIG. 6C is a schematic chart showing alternating power sequence of a light source of the optical inspection module 400 during inspection. The horizontal axis denotes time and the vertical axis denotes light intensity. Pulses 456 indicate light intensity from the LEDs 416 and pulses 457 indicate light intensity form the LEDs 417. In one embodiment, the illumination source assembly 415 may emit light pulses at a frequency twice as high as the LEDs due to the alternating pulses. In one embodiment, the pulses 456 and 457 may be projected at about 14000 frames per second. Referring back to FIGS. 4 and 5, the substrate 401 may be moved by an automation device 430 along the direction of 402 at a rate of about 8 m/minute. The high frequency of the illumination source assembly 415 allows adequate inspection to the substrate moving at such speed.

In one embodiment, the illumination source assembly 415 comprises a diffuser 425 disposed over the LEDs 416 and 417. The diffuser 425 is configured to improve uniformity of the light emitted from the LEDs 416 and 417. In one embodiment, the diffuser 425 may be a random diffuser configured to cause incoming light/energy to be distributed in a wider range of angles and reduce the contract of the projected beam and thus improve spatial uniformity. In general, the random diffuser is narrow angle optical diffuser that is selected so that it will not diffuse the received energy in a pulse at an angle greater than the acceptance angle of the lens that it is placed before.

FIG. 6A is a schematic chart showing intensity 451 of the LEDs 416 without a diffuser across a spatial section the inspection module 400. FIG. 6B is a schematic chart showing intensity 452 of the LEDs 416 after the passing through the diffuser 425. FIGS. 6B and 6A illustrate uniformity improvement by the diffuser 425.

Referring back to FIG. 5, the image sensor assembly 420 comprises one or more cameras 421, such as CCD cameras, and other supporting components that are used to optically inspect various regions of the substrate 401. In one embodiment, the image sensor assembly 420 comprises a plurality of CCD cameras 421 positioned above the illumination source assembly 415, such that the substrate 401 may be translated between the image sensor assembly 420 and the illumination source assembly 415. In one embodiment, the image sensor assembly 420 is in communication with the controller 440.

In one embodiment, the image sensor assembly 420 comprises about 20 cameras 421 arranged substantially along a line corresponding to the illumination source assembly 415. In one embodiment, each camera 421 may comprise light sensing pixels disposed along the line. In one embodiment, each camera 421 has about 8 k pixels arranged along the line.

The automation device 430 may feed the substrate 401 between the image sensor assembly 420 and the illumination source assembly 415 as the substrate 401 is translated through the optical inspection module 400.

In one embodiment, as the substrate 401 is fed through the optical inspection module 400, the substrate 401 is illuminated from one side of the substrate 401 by the illumination source assembly 415, while the image sensor assembly 420 captures images from the opposite side of the substrate 401. The image sensor assembly 420 sends the captured images of the substrate 401 to the controller 440, where the images are analyzed and metrology data is collected.

In one embodiment, the images are retained by portions of the controller 440 disposed locally within the optical inspection module 400 for analysis. In one embodiment, the controller 440 is a system controller and uses the information supplied by the image sensor assembly 420 to determine whether the substrate 401, meets specified criteria. The controller 440 may then take specific action to correct any defects detected or reject the substrate 401. In one embodiment, the controller 440 may use the information collected from the image sensor assembly 420 to diagnose the root cause of a recurring defect and correct or tune the process to minimize or eliminate the recurrence of the defect.

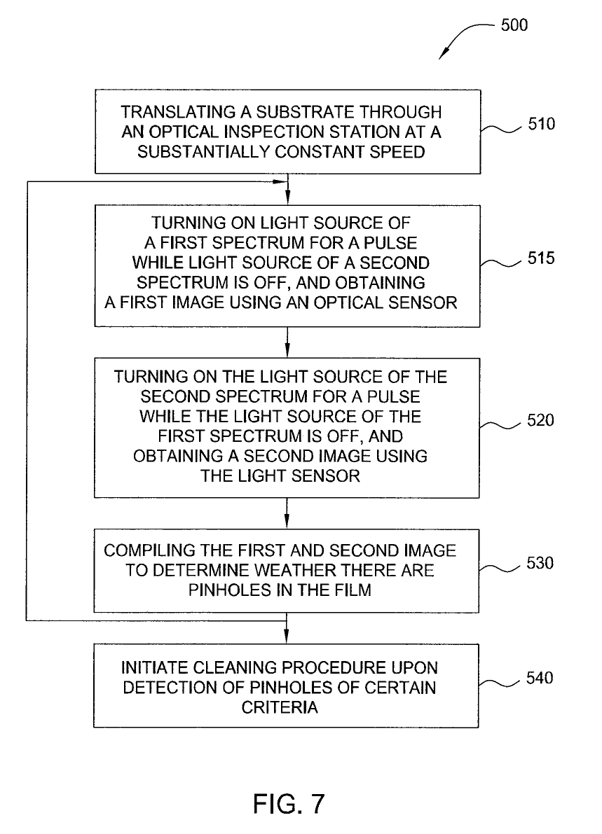

FIG. 7 is a flow chart of a method 500 for inspecting a substrate in accordance with one embodiment of the present invention. Particularly, the method 500 may be performed using the optical inspection module 400 described above.

In box 510 of the method 500, a substrate being inspected is translated through an optical inspection station at a substantially constant speed to allow the substrate being inspected region by region.

In box 515, a light source configured for projecting light within a first spectrum is turned on for a short period while a light source configured for projecting light within a second spectrum is off, and light within the first spectrum that passes through the substrate is captured in a first image. In one embodiment, light within the first spectrum may be absorbed by a first film on the substrate.

In box 520, the light source configured for projecting light within the second spectrum is turned on for a short period while the light source configured for projecting light within the first spectrum is off, and light within the second spectrum that passes through the substrate is captured in a second image. In one embodiment, light within the second spectrum may or may not be absorbed by a film on the substrate.

In box 530, the first and second images are compared to determine the existence of defects on the substrate and the property the detected defects if any.

Processes in boxes 515, 520 and 530 may be repeated until the entire substrate passes through the optical inspection station.

In box 540, cleaning procedures in related chambers may be initiated upon detection of defects, such as pinholes, reach certain criteria. In one embodiment, the substrate may be disqualified for further processing to reduce further waste in production cost.

While the foregoing is directed to embodiments of the present invention, other and further embodiments of the invention may be devised without departing from the basic scope thereof, and the scope thereof is determined by the claims that follow.

What is claimed is:

1. An inspection module for inspecting a substrate, comprising:
a frame allowing the substrate to pass therethrough;
an illumination source assembly attached to the frame, wherein the illumination source assembly comprises:
a first light source providing light of wavelengths in a first spectrum; and
a second light source providing light of wavelengths in a second spectrum;
an image sensor assembly attached to the frame, wherein the substrate is passes through the illumination source assembly and the image sensor assembly, and the illuminating source assembly is positioned to direct light towards the image sensor assembly.

2. The inspection module of claim 1, wherein the first light source comprises a plurality of first light emitting diodes (LED) configured to emit light in the first spectrum, and the second light source comprises a plurality of second light emitting diodes (LED).

3. The inspection module of claim 2, wherein the first and second LEDs are positioned alternately and form a substantially straight line.

4. The inspection module of claim 3, further comprises a diffuser disposed over the illumination source assembly and configured to level light intensity from the first and second LEDs along the substantially straight line.

5. The inspection module of claim 3, wherein the image sensor assembly comprises a plurality of charge-coupled device (CCD) cameras having linearly arranged pixels.

6. The inspection module of claim 3, wherein the plurality of first LEDs emit light of wavelengths in the spectrum of red, and the plurality of second LEDs emit light of wavelengths in the spectrum of blue.

7. The inspection module of claim 1, wherein light within the first spectrum can be absorbed by a first film on the substrate, and light within the second spectrum cannot be absorbed by the first film.

8. The inspection module of claim 7, further comprises a controller coupled to the illumination source assembly and the image sensor assembly, wherein the controller is configured to turn on the first light source and second light source alternately.

9. The inspection module of claim 7, wherein light within the second spectrum can be absorbed by a second film on the substrate.

10. The inspection module of claim 1, wherein the image sensor assembly comprises a plurality of charge-coupled device (CCD) cameras.

11. An inspection module for inspecting a substrate, comprising:
a frame having an opening to allow the substrate to pass therethrough;
a line illumination source attached to the frame at one side of the opening, wherein the line illumination source comprises:
a plurality of first light emitting diodes (LEDs) configured to emit light of wavelengths within a first spectrum; and
a plurality of second light emitting diodes (LEDs) configured to emit light of wavelengths within a second spectrum, wherein the first LEDs and the second LEDs are alternately disposed along a line, and the first spectrum is different from the second spectrum; and
a line image sensor attached to the frame on an opposite side of the opening, wherein the line image sensor is configured to detect light from the line illumination source.

12. The inspection module of claim 11, further comprising a diffuser disposed over the line illumination source and configured to level light intensity along the line.

13. The inspection module of claim 12, wherein the first spectrum is the red spectrum, and the second spectrum is the blue spectrum.

14. The inspection module of claim 11, wherein the line image sensor comprises a plurality of charge-coupled device (CCD) cameras each pixels arranged in a single line.

15. The inspection module of claim 11, further comprising a controller coupled to the line illumination source and the line image sensor, wherein the controller is configured to alternately turn on the first LEDs and the second LEDs.

16. A method for inspecting a substrate, comprising:
feeding a substrate through an inspection station;
inspecting the substrate while moving the substrate through the inspection station, wherein the substrate has a first light absorbing film deposited thereon, and inspecting the substrate comprises:
directing a first pulse of light within a first spectrum from a light source towards the substrate, wherein the first spectrum is absorbable by the first light absorbing film;
measuring the first pulse of light passing through the substrate by capturing a first image using an image sensor assembly, wherein the image sensor assembly and the light source are disposed on opposite sides of the substrate; and
determining whether a hole exists in the first light absorbing film from the first image.

17. The method of claim 16, wherein the substrate has a second light absorbing film deposited thereon, and inspecting the substrate further comprises:
after measuring the first pulse of light, directing a second pulse of light within a second spectrum from the light source, wherein the light within the second spectrum can be absorbed by the second light absorbing film and cannot be absorbed by the first light absorbing film; and
measuring the second pulse of light passing through the substrate by capturing a second image using the image sensor assembly; and
determining whether a hole exists in the second light absorbing film from the first and second images.

18. The method of claim 17, wherein inspecting the substrate further comprises repeating directing the first pulse of light and capturing the first image, and directing the second pulse of light and capturing the second image for the entire substrate.

19. The method of claim 17, wherein directing the first pulse of light comprises pulsing a plurality of first light emitting diodes (LED) configured to emit light in the first spectrum, and directing the second pulse of light comprises pulsing a plurality of second light emitting diodes (LED) configured to emit light in the second spectrum.

20. The method of claim 17, wherein the first spectrum is the red spectrum, and the second spectrum is the blue spectrum.

21. The method of claim 16, wherein directing the first pulse of light towards the substrate comprises directing the first pulse of light through a diffuser.
